(19) United States
(12) Patent Application Publication
(10) Pub. No.: US 2007/0061540 A1
(43) Pub. Date: Mar. 15, 2007

(54) Data storage system using segmentable virtual volumes

(76) Inventors: Jim Rafert, Westminster, CO (US); Randy Pierce, Golden, CO (US); John Tyree, Lakewood, CO (US)

Correspondence Address: HOLME ROBERTS & OWEN, LLP, 299 SOUTH MAIN, SUITE 1800, SALT LAKE CITY, UT, 84111, US

(21) Appl. No.: 11/448,467

(22) Filed: Jun. 6, 2006

Related U.S. Application Data
(60) Provisional application No. 60/687,770, filed on Jun. 6, 2005.

(51) Int. Cl. G06F 12/00

(52) U.S. Cl. 711/170

(57) ABSTRACT

A system and method for a block storage device that can present as multiple virtual block storage devices (volumes) over a SAN, multiple shared file systems over a NAS or both simultaneously.

### BACKGROUND OF THE INVENTION

1. The Field of the Invention

The present invention relates generally to data storage and, more specifically, to a block storage device that can present as multiple virtual block storage devices (volumes) over a SAN, multiple shared file systems over a NAS or both simultaneously.

2. The Relevant Technology

Everyone is familiar with data storage and the need for improved ways of storing and retrieving massive amounts of data. There are an almost infinite number of possible solutions. However, given the number of choices, there are many problems associated with storage. For example, the underutilization an inefficient provisioning of an installed disk and allocating high cost fast storage for an entire virtual volume results in a significantly higher cost of storage. In may instances, there is a significant loss of business related to downtime for restructuring, resizing and maintenance of databases and disk volumes. Migrating data to low cost storage in many cases fails to alleviate the problem since there are significant costs associated with such an endeavor. Quite simply, there are high administrative costs associated with disk allocation management and data recovery.

It would therefore be desirable to provide a block storage device that may present as either multiple virtual block storage devices (volumes) or multiple shared file systems.

### BRIEF SUMMARY OF THE INVENTION

A storage system of the present invention includes a system and method for creating a number of virtual volumes and allocating storage space from a common storage pool to each. Common storage pools are a shared resource from which all allocated virtual volumes draw storage on an as-needed basis. Accordingly, more storage can be added to common storage pools as needed, without the need for resizing or interrupting the operations of the already allocated and operating virtual volumes, even though they may take advantage of the increased storage space. Such an operation allows storage purchases at the time they are needed rather than when the appliance is initially configured. A virtual volume both acquires storage from the common storage pool when data is written to it and releases storage back to the common storage pool when it is no longer needed. Storage is therefore allocated from the storage pools to store information written to the virtual volume.

A system and method for storing data in a queue of data entries that are ordered chronologically by time of insertion into said queue is also disclosed. A list of a plurality of data items is provided. Each data item has a unique storage address range that identify regions of storage on a storage device associated therewith. A data structure is also provided. The data structure of the present invention is configured for receiving a portion of the plurality of unique storage address ranges from a pool of addresses and returning a portion of the plurality of unique storage addresses to the pool of said addresses. The data structure is extensible or contractible without having to rewrite said data structure. A data item is stored in the data structure. The data item has a storage address in the queue that is determined at the time that said data item is stored in said data structure. In addition, the storage address is immutable without regards to any insertions and deletions from said data structure.

The system and method also includes a method of data access. Data blocks are stored in a journal having an associated index. The data blocks are paired with metadata blocks that store information, including a virtual address and a journal address of the data block. Unpaired time records are stored in a metadata block that are configured to describe a point in time in the journal. Time records are configured such that records appearing earlier in said journal were written at or before the identified point in time, and records appearing later in said journal were written at or after the identified point in time. Accordingly, the index is configured to have a searchable list of virtual and journal addresses of the most recent additions to the journal of each unique virtual address range.

Data blocks are then retrieved that are associated with any virtual address by first searching the index. Data is then retrieved from the journal at a recorded journal address The data block associated with a virtual address is logically replaced in subsequent write operations by performing at least one step chosen from the following: (1) adding the data block to the end of said journal and updating said index; (2) overwriting the data blocks whose virtual addresses are represented in the journal; and (3) adding, to the end of the journal, a plurality of data blocks whose virtual addresses are not represented in the journal.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a DSS including Storage pools, Administrative Interface, Data Interfaces and VirtualVolumes;

FIG. 2 illustrates VirtualVolume and VolumeSegments;

FIG. 3 illustrates different VirtualVolume and VolumeSegment configurations;

FIG. 4 illustrates a VolumeSegment structure;

FIG. 5 illustrates a journal structure with data store, metadata store and TimeRecords;

FIG. 6 illustrates a Tip index structure;

FIG. 7 illustrates writing user data to VirtualVolume with CVS (data, metadata, tip index);

FIG. 8 illustrates writing user data to VirtualVolume with a DVS (data, metadata, tip index);

FIG. 9 illustrates a read request originating from client, passing through a data Interface to a VirtualVolume;

FIG. 10 illustrates a VolumeSegments searched in order of age to satisfy client read request;

FIG. 11 illustrates a tip index is searched for address ranges that intersect with a client address range;

FIG. 12 illustrates a list of generated Hits and Misses;

FIG. 13 illustrates a CVS or LVS tip index updated to reflect a write operation;

FIG. 14 illustrates a DVS tip index updated to reflect a write operation;

FIG. 15 illustrates the structure of a DLQ;

FIG. 16 illustrates deleting records from the front of a DLQ;

FIG. 17 illustrates deleting records from the end of a DLQ;

FIG. 18 illustrates the concept of VirtualVolume Inheritance;

FIG. 19 illustrates a Child VirtualVolume reading from a parent;

FIG. 20 illustrates data migration between VolumeSegments showing policy parameters;

FIG. 21 illustrates block compression removing data with redundant sector address ranges;

FIG. 22 illustrates failover clusters based on shared storage;

FIG. 23 illustrates failover clusters based on replicated storage;

FIG. 24 illustrates DSS to DSS replication at time of write to CVS;

FIG. 25 illustrates DSS to DSS replication at time of data movement/transformation between segments; and

FIG. 26 illustrates DSS to other storage replication.

### DETAILED DESCRIPTION OF THE PREFERRED EMBODIMENTS

Reference will now be made in detail to the preferred embodiments of the present invention, examples of which are illustrated in the accompanying drawings. The various exemplary embodiments provide a block storage device that may present as either multiple virtual block storage devices (volumes) over a SAN or multiple shared file systems over a NAS, or in some cases both simultaneously.

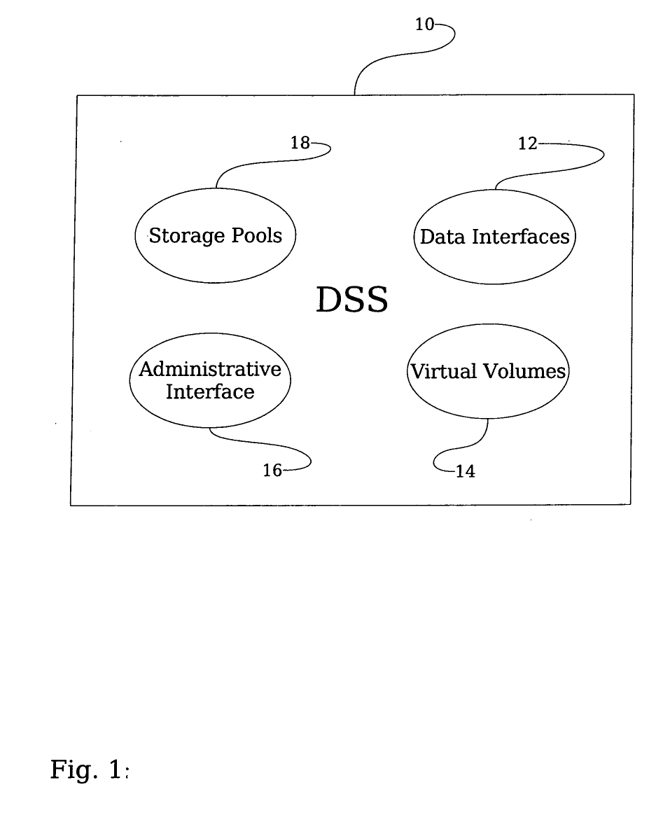

Referring to FIG. 1, one embodiment of a Data Storage System (DSS) 10 of the present invention is illustrated. In the illustrated embodiment, the DSS 10 is comprised of one or more components, including a plurality of VirtualVolumes 14. Additional components may be added to the DSS 10 such as a plurality of storage pools 18, an administrative interface 16 and a plurality of data interfaces 12 to name a few. Each of the illustrated DSS components are described in the paragraphs that follow. It should be appreciated that additional components of the DSS 10 that are not illustrated in FIG. 1 may be utilized without departing from the scope and spirit of the invention. In addition to the components illustrated in FIG. 1, the DSS 10 may contain additional subcomponents also described later in this document.

Common storage pools 18 are a shared resource from which all allocated VirtualVolumes draw storage on an as-needed basis. More storage can be added to the common storage pools 18 as needed, without the need for resizing or interrupting the operations of the already allocated and operating VirtualVolumes 14, even though they may take advantage of the increased storage space. This allows storage purchases at the time they are needed rather than when the appliance is initially configured.

VirtualVolumes 14 both acquire storage from the common storage pool 18 when data is written to them and release storage back to the common storage pool 18 when no longer needed. Storage is allocated from the pools to store information written to the VirtualVolume 14. Percieved storage space is not fully allocated when the VirtualVolume 14 is created.

In operation, DSS 10 may obtain raw storage for VirtualVolumes 14 and other structures from one or more storage pools 18. Each storage pool 18 may be a collection of Extents from one or more storage devices that may be directly attached to the DSS 10 or remotely attached over a network (not illustrated). Such devices may include a hard disk, tape drive, optical disk, RAID arrays, solid state disk and devices with virtual interfaces of various types to name a few.

As used herein, an Extent is a unique addressable region on a storage device which has a defined addressable device location, is contiguous within the device addressing scheme and has a finite length. In one aspect of the invention, Extents of a given storage pool 18 are equal in length. In addition to equal length Extents, variable length Extents may be used. Storage pool 18 may be differentiated by properties such as speed of access, locality of access, physical location, security of storage, permanence of storage, cost of storage and level of RAID protection. Multiple storage pools may be used to an advantage even when the storage devices are indistinguishable from each other for the convenience of certain algorithms employed by the DSS 10, or the convenience or preferences of the administrator of the DSS 10.

DSS 10 may have zero or more VirtualVolumes 14. VirtualVolume 14 is a virtual interface that emulates the properties of any of a number of block storage devices such as hard disk, a hard disk partition, tape, floppy disk, optical disk, RAID arrays, solid state disk to name a few. Any block storage device may be used that fits within the scope and spirit of the present invention. A preferred embodiment of VirtualVolume 14 exposes certain interfaces that allow access by the DSS data interfaces and by the DSS administrative interface. In one embodiment of the present invention, block level I/O requests are passed into the DSS data interface 12 and processed by a VirtualVolume 14. VirtualVolumes are created and configured through the administrative interface 16. Administrative interface 16 may be removed and one or more default VirtualVolumes 14 have a fixed configuration. Through its subcomponents, VirtualVolume 14 may store and retrieve data written to it. Data may also be cataloged, extracted, transformed or otherwise modified or enhanced.

One embodiment of the DSS utilizes a set of data interfaces 12 that allow clients external to the DSS to perform input/output on the VirtualVolumes 14 inside the DSS 10. Data interface 12 may include such well known industry standards as SCSI, iSCSI, FibreChannel, USB, FireWire, SMB, CIFS, FTP, HTTP and NFS to name a few. An alternate embodiment of the present invention may be implemented for local usage by a single server without an interface.

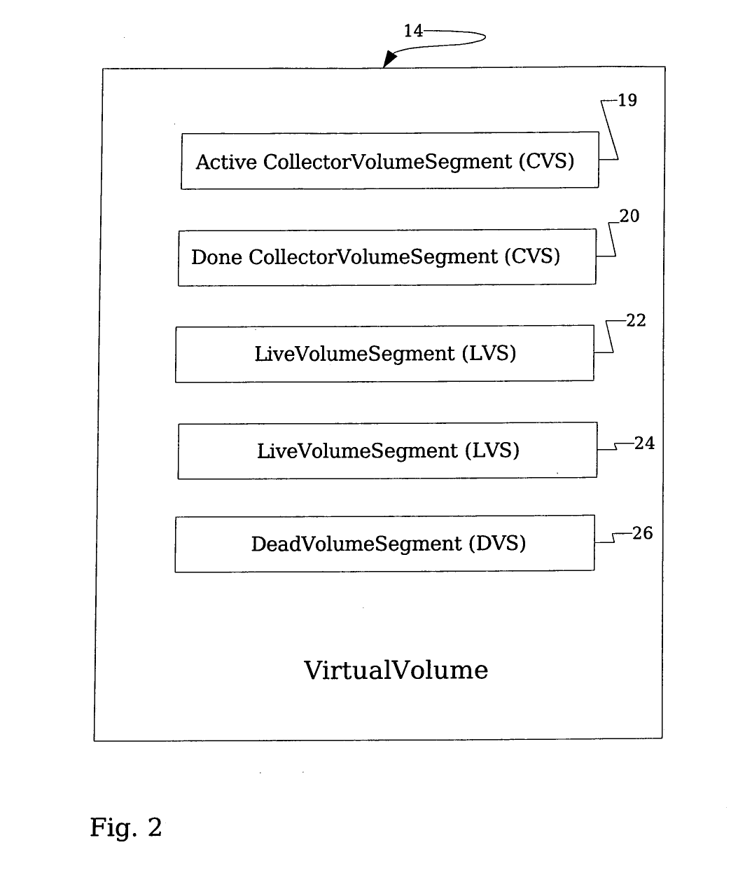

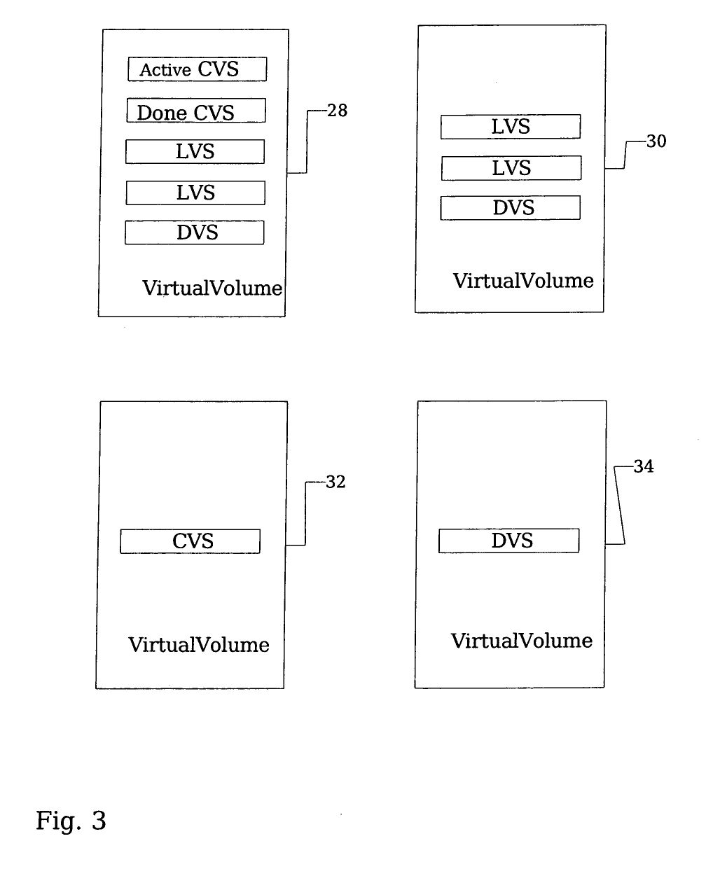

As shown in FIG. 2, VirtualVolume 14 has an ordered set of one or more VolumeSegments. In the illustrated embodiment, VirtualVolume 14 comprises an Active CollectorVolumeSegment (CVS) 18, a Done CollectorVolumeSegment 20, a first LiveVolumeSegment (LVS) 22, a second LiveVolumeSegment 24 and a DeadVolumeSegment (DVS) 26. VirtualVolume 14 may have any combination of CVS, LVS and DVS—the illustrated configuration is for ease of description. The properties of VirtualVolume 14 depend, at least in part, upon the number and type of VolumeSegments. For example, a VirtualVolume 14 having at least one LVS, but no CVS is read-only. As another example, a VirtualVolume 14 having no CVS or LVS, but with a DVS is referred to as a sparse volume that lacks the ability to mark points in time (TimeRecords). Accordingly, as illustrated in FIG. 3, multiple configurations of VirtualVolumes 28, 30, 32, 34 for different applications may be created by varying the VolumeSegments.

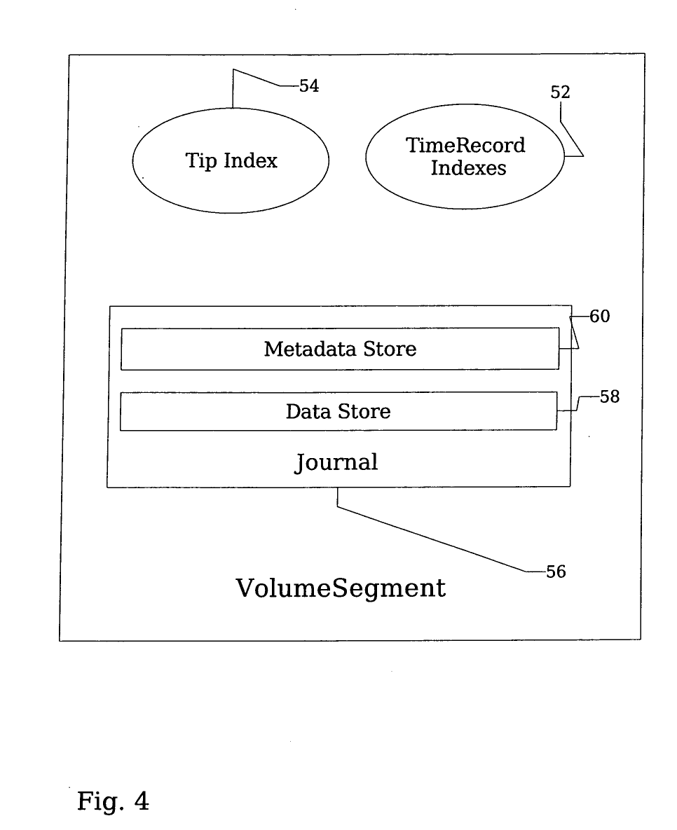

FIG. 4 shows a VolumeSegment 50 in accordance with one aspect of the present invention. VolumeSegment 50 is a storage object that maps client addresses to data store addresses. VolumeSegment 50 has a journal 56 and a tip index 54. The journal 56 comprises the data store 58 and metadata store 60. VolumeSegment 50 may also have one or more TimeRecord indexes 52. In the illustrated embodiment, tip index 54 maps client addresses of reads and writes to addresses in the data store 58. There are three types of VolumeSegment elements—e.g., CVS, LVS and DVS—detailed in the following paragraphs, however, the invention is in no way limited to only three elements.

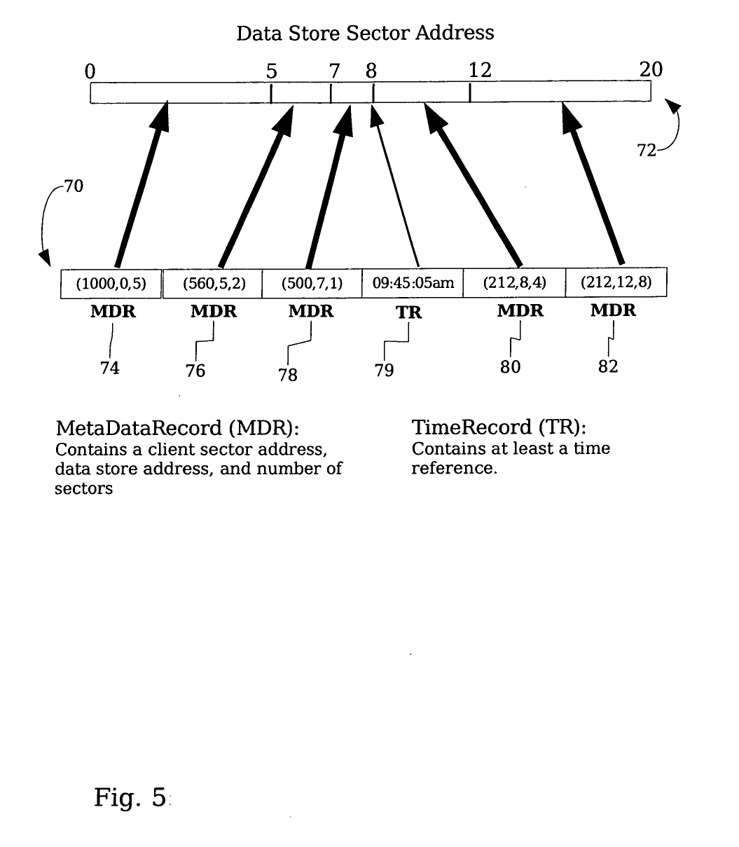

Continuing with FIG. 5, a journal 56 is comprised of a data store 72 and metadata store 70. Data store 72 and the metadata store 70 are stored separately in two DynamicLinearQueue (DLQ) objects, the data DLQ and the metadata DLQ (not illustrated). Data store 72 and metadata store 70 may be stored in any type of data structure such as singly or doubly linked linear queues, circular queues, binary tree objects, flat files or any other data structure that has the ability to maintain the chronological order of data written to it. Data store 72 and metadata store 70 may be combined into a single storage object. It is also contemplated that either metadata store 70 or data store 72 may be broken into several different objects. For example, metadata store 70 may have several parts, with each part holding a single record type.

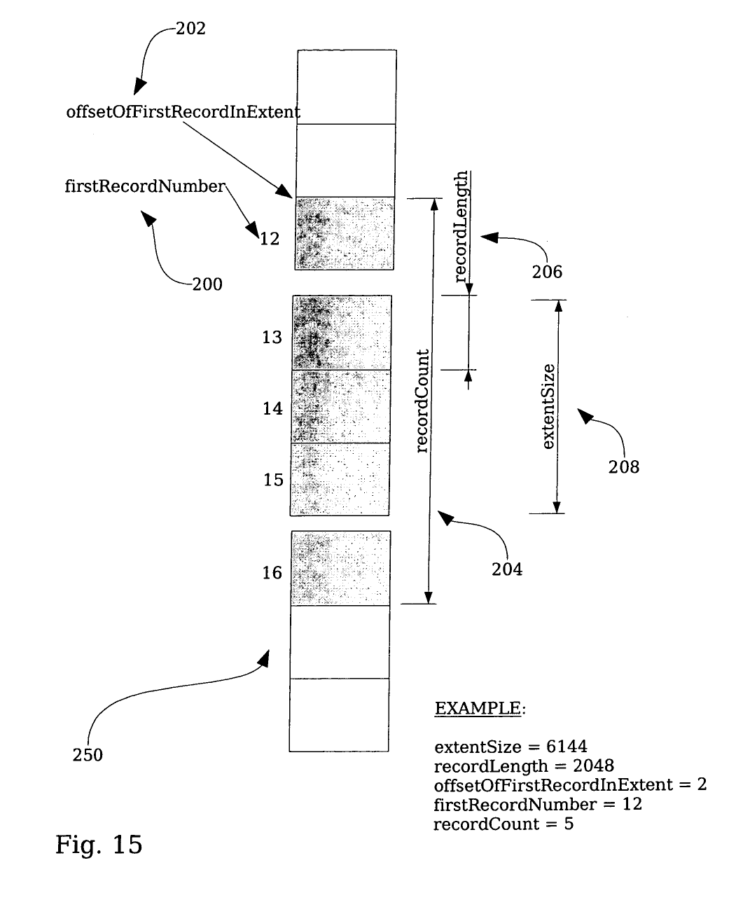

As used in accordance with the present invention, a Dynamic Linear Queue (DLQ) is a storage object (illustrated and described as reference 250 in FIG. 15). There are several properties associated with the DLQ, and a few of them are listed and described hereafter. First, when a record is written to a DLQ, it is written at the end of the queue. Second, records anywhere in the queue can be modified if their address in the queue is known. Third, records are normally deleted from the front of the queue, although it is also possible to delete records from the end of the queue. In a preferred embodiment of the present invention, records may not be deleted from the middle of the queue, although a person of ordinary skill in the art can easily see that middle-queue deletions could be accomplished in several ways. One such example is maintaining a list of addresses of logically deleted records. Fourth, when a record is written, it is assigned a unique address in the queue which is immutable over time. The address typically does not change, even if records in front of the addressed record are deleted.

A DLQ has a collection of Extents into which records are written and stored. Extents are acquired from a storage pool when needed by a DLQ and returned to the storage pool when no longer needed.

Data store 72 holds the client data written to a VolumeSegment. Metadata store 70 holds derived MetaDataRecords, TimeRecords, and also other record types associated with various marks which may be inserted either automatically by the DSS or by a user or administrator.

MetaDataRecord 74, 76, 78, 80, 82 typically is defined by a client address, a data store address and a length. For example, MetaDataRecord 74 has a client address of 1000, a data store address of 0 and a length of 5. The metadata store 70 also has the ability to hold a series of TimeRecords 79 that mark points in time associated with a data store address. TimeRecord 79 has a time and is associated with an address in the data store. In one embodiment of the present invention, TimeRecord 79 contains a time, an address in the data store, the address of the TimeRecord in the metadata store and a type variant field. Of course it should be readily apparent to one of ordinary skill in the art that not all fields of the TimeRecord are necessary, and other information may be included that depends upon the structures in which the data and metadata stores are recorded and processing convenience of algorithms used to implement various functions of the DSS. For example, in an alternative embodiment, the data store 72 and metadata store 70 are combined in a single ordered object, resulting in the condition that only the time would be required to be stored. In yet another embodiment, TimeRecords may be stored separately from the metadata store 70 and the data store 72.

Different VolumeSegments may be made up of storage from different storage pools having differing properties. Accordingly, differing storage pool assignments may be made for the data store and metadata store of each VolumeSegment.

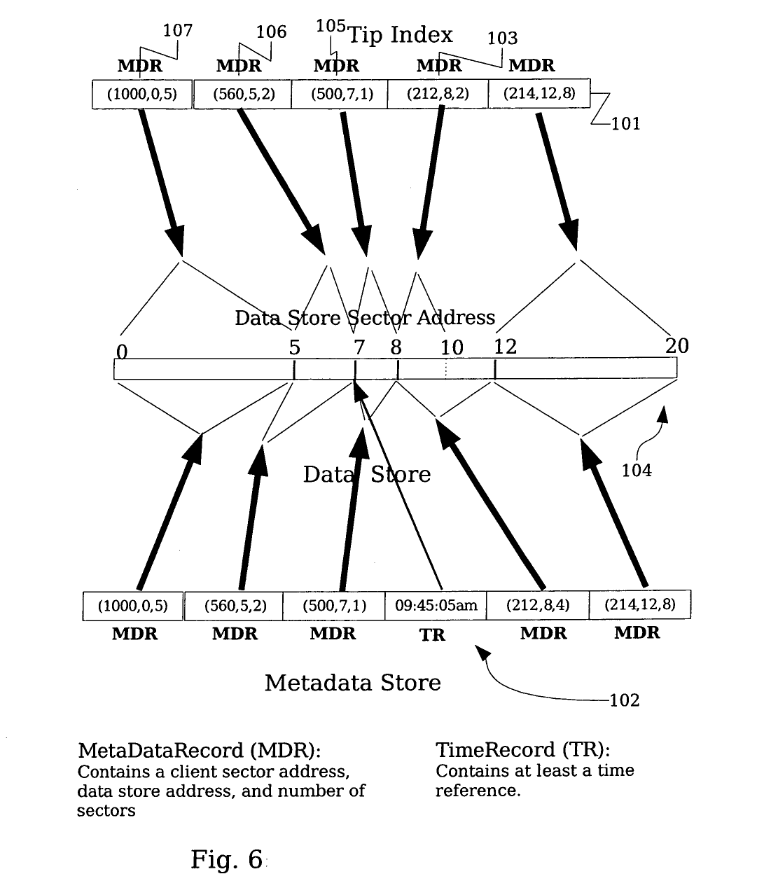

In the illustrated embodiment of FIG. 6, VolumeSegment 50 has a tip index 100 that is a collection of MetaDataRecords 101, 103, 105, 106, 107 that collectively represent references to the data store addresses in data store 104 of the most recently written version of data written to client addresses, over the entirety of data stored in the VolumeSegment 50.

A CVS and LVS may have anywhere from zero to several TimeRecord indexes. By definition, a TimeRecord index is a collection of MetaDataRecords that collectively represent references to the data store addresses of the most recently written version of data written to client addresses between the beginning of the data store and a data store address corresponding to a TimeRecord. As shown, the TimeRecord is also an entry in the metadata store 102.

Preferably, an administrative interface is provided for configuring not only DSS policy but also policies of VirtualVolumes in the DSS. It should be understood, however, that the present invention may be implemented with no administrative interface at all. Such an interface receives and responds to local or remote client requests. Remote client requests may be sent over a network using network protocols that include but are in no way limited to hypertext transport protocol (http) and secure shell protocol (ssh). One embodiment of the invention has a command line interface that can initiate the administrative commands and display their responses. Typically, such administrative commands may be initiated locally on the DSS or remotely using ssh. In operation, the command line interface provides a mechanism for scripting the administrative commands into a batch program.

There are several types of DSS policy that may be configured in accordance with the present invention, including but not limited to the following, (i) Event, Error, Trace logging levels/toggling control; (ii) Error/Event notification behavior and thresholds; (iii) access control including DSS access and Volume access; (iv) storage pool creation and modification; (v) user authentication; (vi) file system data interface enabling; (vii) network volume sharing; and (viii) generic system settings such as calendar, time, network identification, network resource identification (email and Domain Name Servers, etc.) and localization settings.

Similarly, there are several types of VirtualVolume policy that may be configured in accordance with another aspect of the present invention, including but in no way limited to the following, (i) VirtualVolume creation/destruction; (ii) inherited VirtualVolume creation/destruction; (iii) number and type of VolumeSegments in a VirtualVolume; (iv) storage pool assignment for a VolumeSegment in a VirtualVolume; (v) receiving interval (time) between TimeRecords in a VolumeSegment; (vi) minimum retention duration (in units of number of receiving intervals or time) required for each VolumeSegment; (vii) kind(s) of data manipulation/transformation performed on data that is moved from one VolumeSegment to another VolumeSegment or data within a VolumeSegment; (viii) TimeRecord insertion; and (ix) modifying the Scheduler by adding/deleting/modifying Schedules.

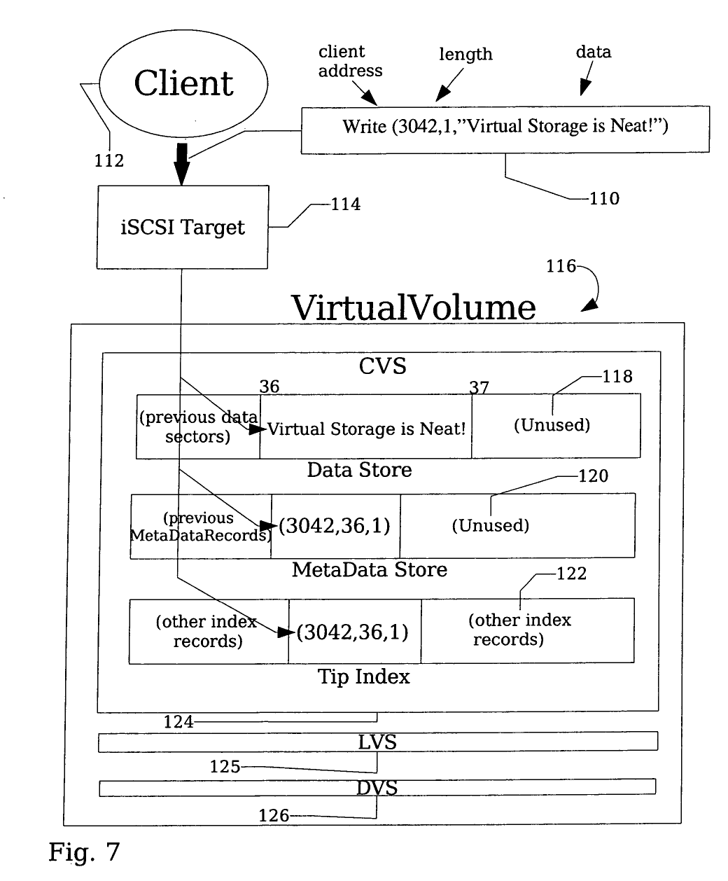

In operation, as illustrated in FIG. 7, a write request 110 may originate from a client host 112, which may also be a general purpose server in which the DSS is embedded, another DSS or elsewhere. The request may be passed through a data interface 114 such as a SCSI, iSCSI, FibreChannel, USB, FireWire, SMB, CIFS, FTP, HTTP or NFS to the associated VirtualVolume 116. Typically, the write request 110 comprises at least a client address range and a write buffer address. Write speed is optimized over non-journaling devices because writes are “serialized,” meaning that writes which would normally cause head or media movement or rotational delay because of non-adjacent storage addresses are now written to adjacent addresses on storage, with the journals and indexes keeping track of address information.

Once the write request 110 is received, if available, a VirtualVolume 116 will write information to the CVS 124. The data is appended to the end of the data store 118 and a MetaDataRecord is appended to the metadata store 120. The tip index 122 is updated to account for the new client address range representing the data. As shown in the illustrated example, a write request 110 having a client address that is contiguous to the end address of the previous write request may be optimized by updating the last MetaDataRecord in the metadata store 122 instead of adding a new one, and adjusting the tip index 122.

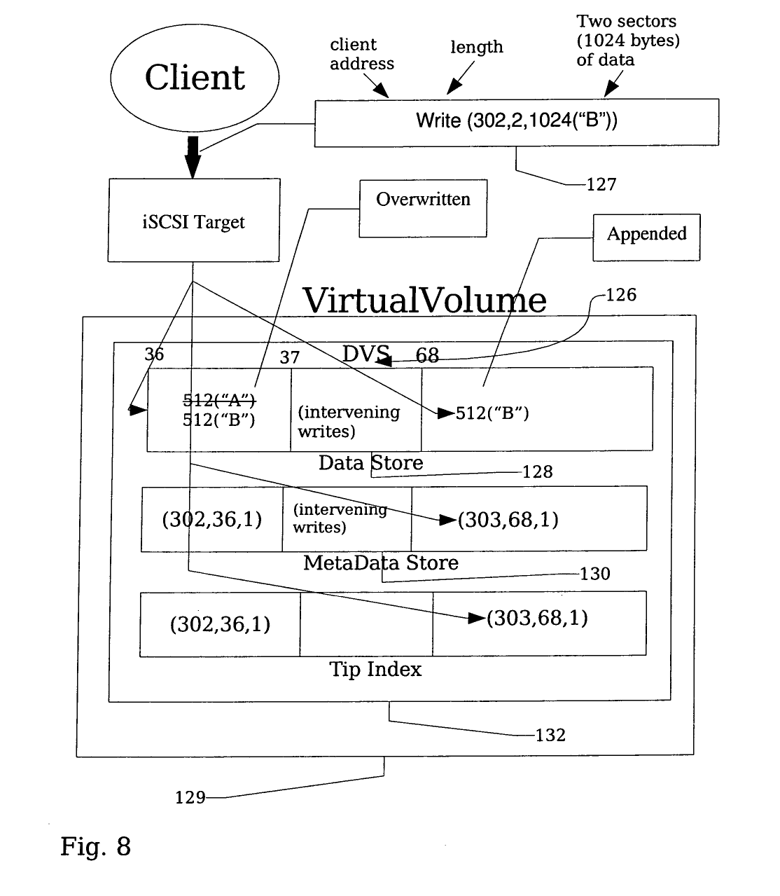

It should be understood that a VirtualVolume without a CVS 124, but having at least one LVS 125, is not writable (not shown). As shown in FIG. 8, a VirtualVolume 127 with no CVS or LVS, but with a DVS 126, may be writable, and under such a condition, a write request 127 is written directly to the DVS 126. The data is either appended to or written over a part of the data store 128. When writing to a DVS 126, the segment or segments of the write request 127 corresponding to a particular client address range that does not overlap with any address range represented in the DVS tip index 132 is appended to the data store 128. In the illustrated example, one or more MetaDataRecords are appended to the metadata store 130 and the tip index 132 is updated to account for any added new client address range.

Continuing with the illustrated example, a portion or portions of write request 127 having a corresponding client address range that overlaps with any address range represented in the DVS tip index 132 is overwritten in the data store 130. In this example, there is no need to add or update MetaDataRecords in the metadata store or update the tip index. A write request 127 having a contiguous client address with the client end address represented in the latest MetaDataRecord that was written to the metadata store 130 and also having a client address range that is not represented in any part in the tip index 132 may be optimized by updating the last MetaDataRecord instead of adding a new one.

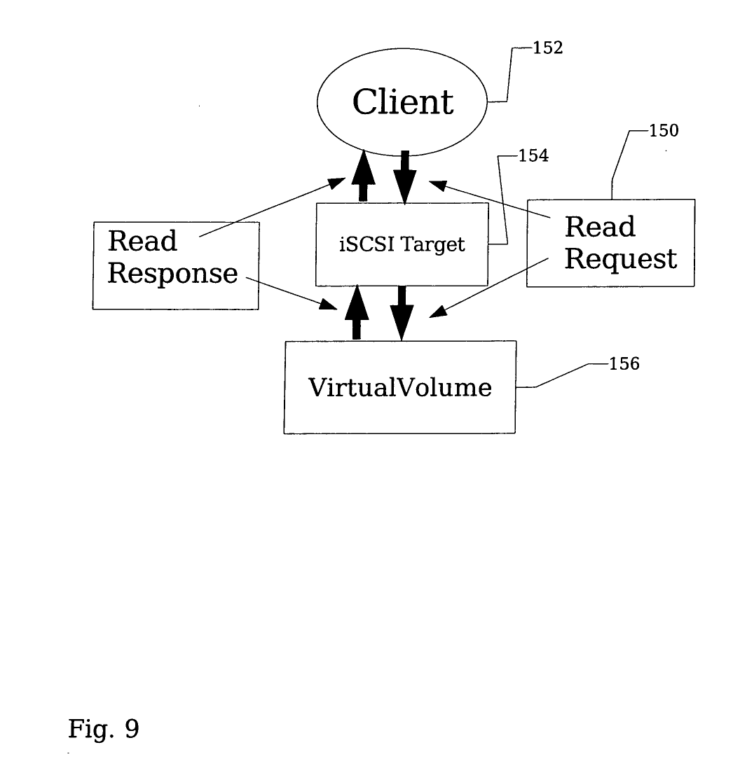

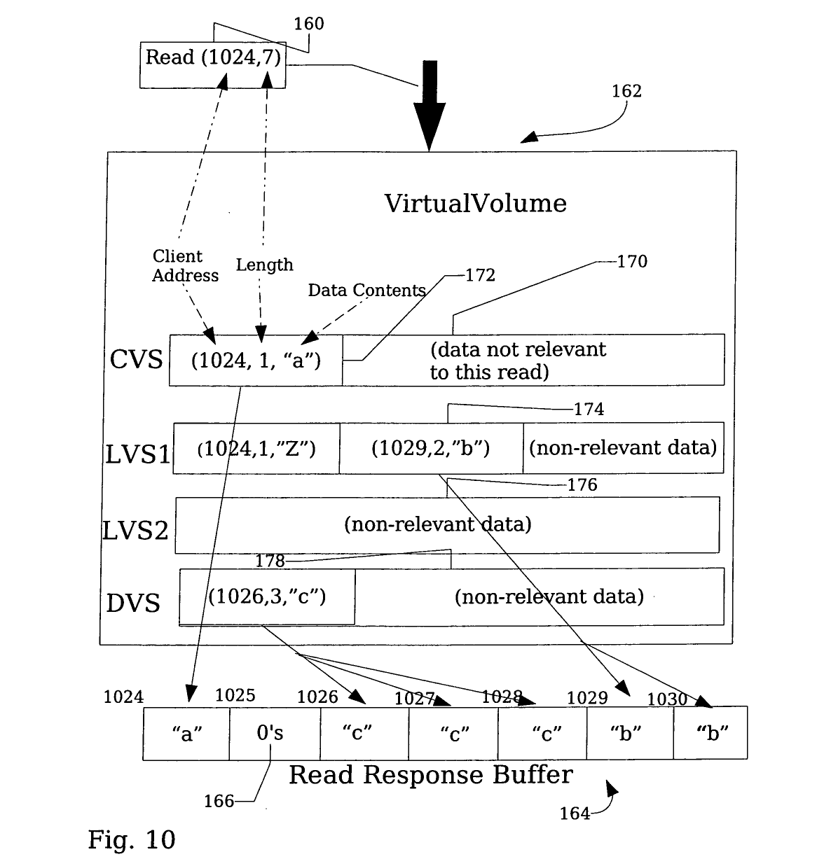

As shown in FIG. 9, a read request 150 may originate from a client host 152, which may also be a general purpose server in which the DSS is embedded, another DSS or elsewhere. In the illustrated embodiment, the read request 152 is passed through a data interface 154 to the target listener (not illustrated). Data interface 154 may include a SCSI, iSCSI, FibreChannel, USB, FireWire, SMB, CIFS, FTP, HTTP and NFS to name a few. The target listener passes the read request to the associated VirtualVolume 156. In operation, the read request 150 comprises at least a client address range and a read buffer address. The read result for that client address range is returned into the read buffer (illustrated as reference numeral 164 in FIG. 10).

FIG. 10 illustrates one example of searching a VolumeSegment to satisfy a read request 160. VirtualVolume 162 is a sparsely populated volume—i.e., not all possible client address ranges are represented by data in the VolumeSegments. Because of the journaled nature of VirtualVolume 162, only the data that is actually written to VirtualVolumes is stored. Storage addresses (e.g., sectors) that have never been subject to a write operation accordngly have no physical storage allocated to them and are assumed to be filled with zeros. Such an arrangement eliminates the costs associated with allocated but unused storage space.

Consequently, a read operation attempts to satisfy the requested client address range by reading in turn from all the VolumeSegments (from youngest to oldest). As shown in FIG. 10, if the full client address range of the read is satisfied after reading less than all the VolumeSegments 172 of, for example, CVS 170, then no further VolumeSegments will be read and the result 168 is returned and stored in the read response buffer 164. If a portion or portions of the request client address range are not found after reading all VolumeSegments, such as CVS 170, LVS1 174, LVS2 176 and DVS 178, then the unsatisfied part of the request is filled with zeros and the result 166 is returned and stored in the read response buffer 164.

Each read request performed on a VolumeSegment utilizes the tip index (not illustrated) to determine the parts of the request client address range that are present and not present in the particular VolumeSegment. If a part of the request is present, the associated information is read from the data store and placed in the appropriate part of the read response buffer 164. The parts of the request that are absent are returned from that VolumeSegment, subsequently read and thereafter passed to the next VolumeSegment. Typically, the read request in the new VolumeSegment is then performed in the same way as the read request in the previous VolumeSegment.

A tip index—as that term is used within the present description—is a collection of MetaDataRecords or transforms of MetaDataRecords that are ordered by client address. The exact data structure used to hold the collection is not an important aspect of the present invention. The following algorithms for searching a tip index are for illustrative purposes only and can be implemented using a variety of data structures such as a linked list, a sorted list, a b-tree, a red-black tree, an array, or a map to name a few. It should be appreciated that any data structure may be used in conjunction with the present invention so long as the structure is searchable by client address. The algorithms are described as a series of steps, and each step may or may not be critical to the performance of the respective algorithm.

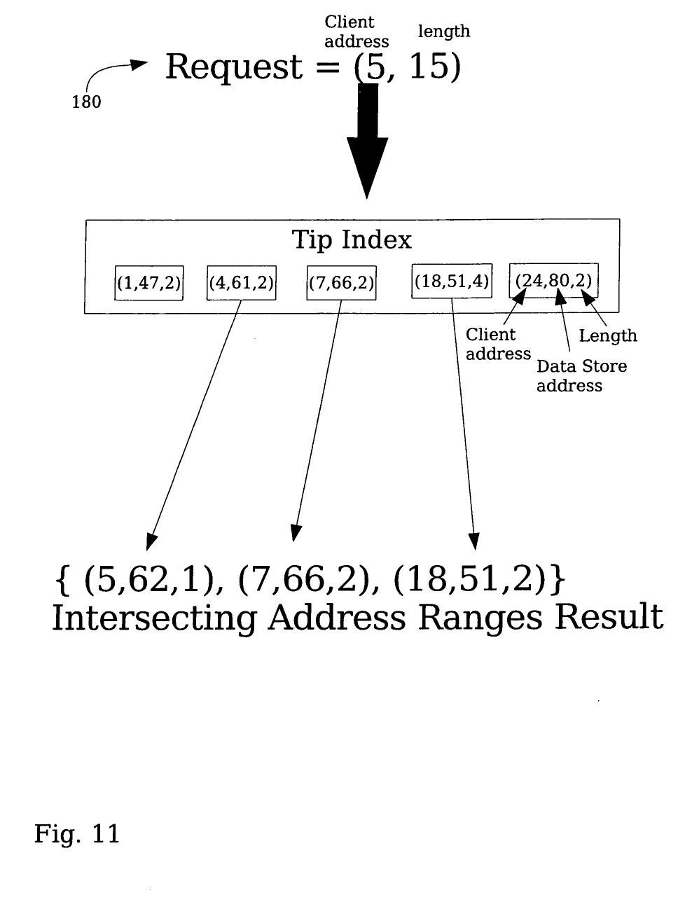

Algorithm 1: As shown in FIG. 11, this algorithm searches the index for client address ranges that intersect with a given client address range within the request 180. Accordingly, the steps of the Algorithm 1 are outlined below. First, find the last MetaDataRecord (MDR) with client address less than or equal to the starting address of the given range—which becomes the current MDR. Next, if no records are found, the first MDR in the collection becomes the current MDR. Then, compute the end address of the current MDR and the given range. While the current MDR client address is less than or equal to the given range end address, if the current MDR client address range intersects with the given range, create a new MDR that represents only the intersection of the current MDR and the given range, add the resulting MDR to the list of intersecting ranges, get the next MDR in the collection, which becomes the current MDR and compute the end address of the current MDR.

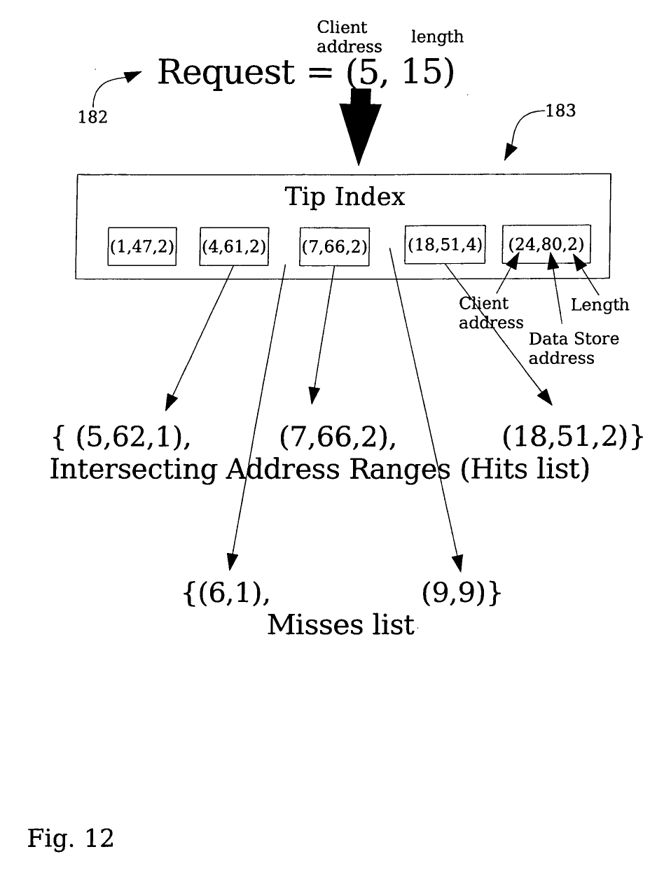

Algorithm 2: As illustrated in FIG. 12, the described algorithm creates a list of ‘hits’ and ‘misses’ that represents the parts of the request 182 that are either represented, or not represented in a given tip index, respectively. The steps of Algorithm 2 are defined as follows. First, search the tip index 183 for intersecting ranges as shown in Algorithm 1 illustrated and described with respect to FIG. 11. Next, Set the miss range start to the starting client address of the request. Then, iterate through the MDR list returned from the performance of the steps of Algorithm 1 described above (for each MDR): If the current MDR client start address is greater than the miss range start, then set the miss range length=(the current MDR client start address−the miss range start), add miss range to list of misses and set the miss range start to (the current MDR client start address+the current MDR length); If the last MDR start address+length is less than the request start+length, then set the miss range length to (request start+length)−(MDR start address+length) and, add the miss range to the list of misses.

It should become apparent to one of ordinary skill in the art from the descriptions of Algorithm 1 and Algorithm 2 that Algorithm 2 may be implemented in the same loop as Algorithm 1 to create a list of hits and misses simultaneously.

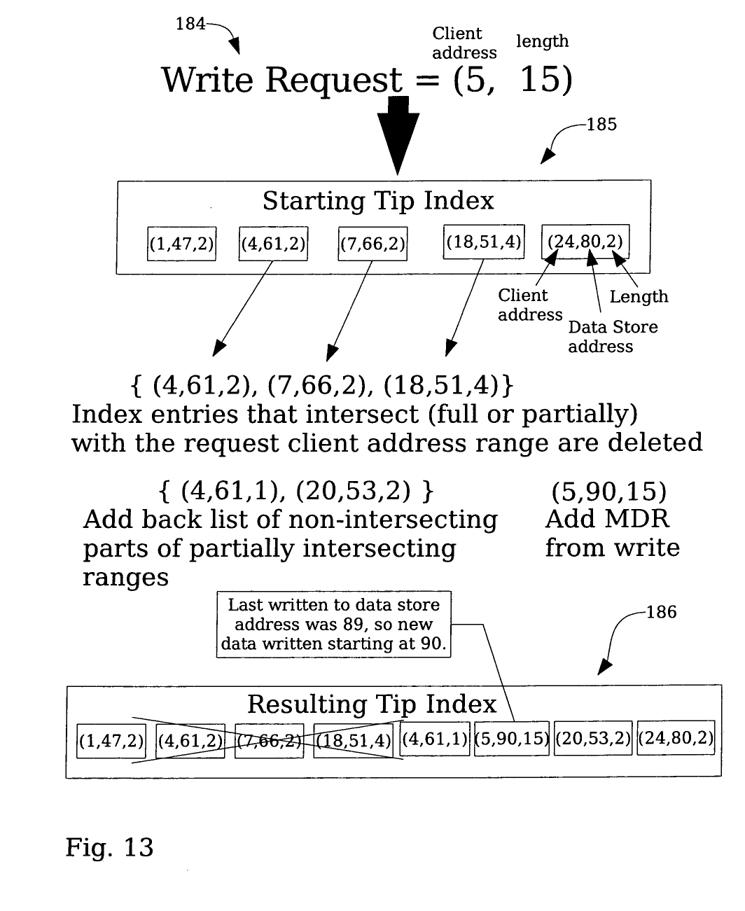

Algorithm 3: As shown in FIG. 13, this illustrated algorithm updates the resulting tip index 186 to reflect a write 184 to a CVS or LVS. The steps associated with Algorithm 3 are explained in the following description. First, find the last MetaDataRecord (MDR) with client address that is less than or equal to the starting address of the insert MDR, which becomes the current MDR. If no records are found, the first MDR in the collection becomes the current MDR. Next, compute the end addresses of the current MDR and the insert MDR. Add the insert MDR to the add list. While the current MDR start address is less than the insert MDR end address, if the current MDR end address is less than or equal to the insert MDR start address, then skip the rest of the steps for this MDR. Otherwise, add the current MDR to the delete list. If the current MDR start address is less than the insert MDR start address, create a new MDR which represents only the portion of the current MDR range that is different (lower address range) from the insert MDR range and add the resulting MDR to the add list. If the current MDR end address is greater than the insert MDR end address, then create a new MDR which represents only the portion of the current MDR range that is different (higher address range) from the insert MDR range and add the resulting MDR to the add list. Delete the delete list from the resulting tip index 186 and add the add list to the same.

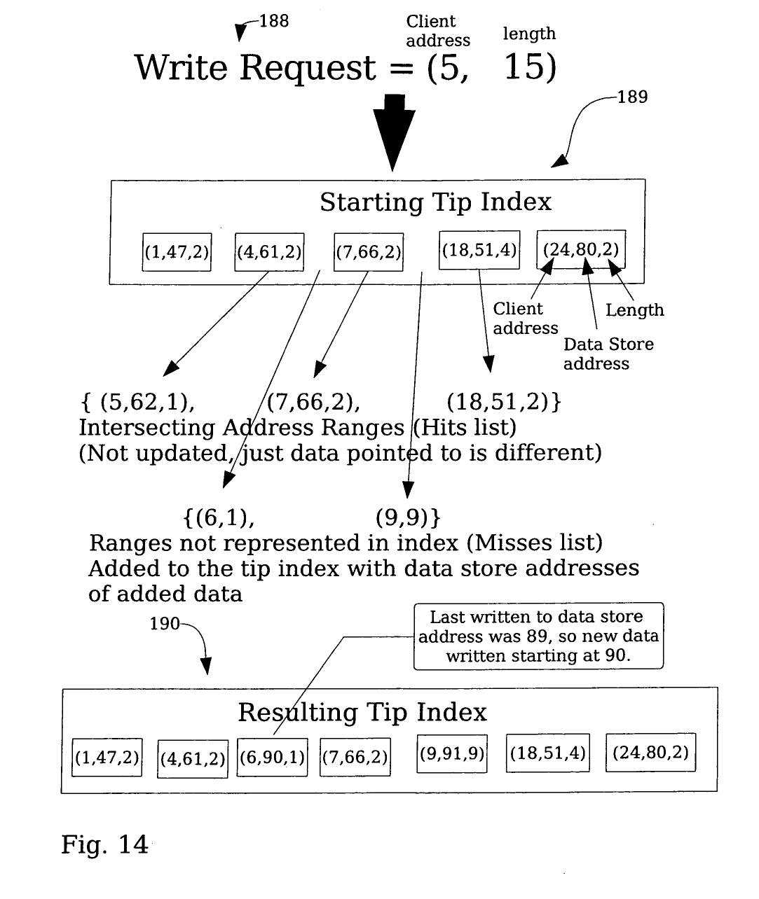

Algorithm 4: As illustrated in FIG. 14, this algorithm updates the starting tip index 189 to reflect a write request 188 to a DVS. The steps of Algorithm 4 follow. When writing to a DVS, some of the data as determined by Algorithm 1 is updated into pre-existing data locations. These pre-existing data locations are already indexed in the tip index and therefore require no work. Parts of the request that are not already represented in the index determined in accordance with Algorithm 2 are written to the end of the data store, and new entries are inserted into the resulting tip index 190 for each ‘miss’ entry returned by Algorithm 2.

As shown in FIG. 15, DLQ 250 is implemented as an ExtentList, which in one embodiment of the invention is implemented as a circular queue of Extent objects. An ExtentList does not necessarily require a Circular Queue, but may be implemented using any number of data structures that implement a list. DLQs obtain new extents from, and release extents back to a storage pool, which is also an ExtentList.

DLQ 250 maintains at least five items of information that allow it to calculate addressing. The five items are the absolute record number of the first record represented in the queue (firstRecordNumber) 200; the offset of the first record from the beginning of the first extent (offsetOfFirstRecordInExtent) 202; the number of records represented in the queue (recordCount) 204; the length of queue records (recordLength) 206; and the length of the extents in the queue (extentSize) 208. The following illustrative algorithms use the above referenced information.

Algorithm 10: Determine the logical extent number and extent offset of a DLQ record number.
Extent number=((recordNumber—firstRecordNumber)*recordLength+offsetOfFirstRecordInExtent)/ExtentLength
Extent Offset=((recordNumber—firstRecordNumber)*recordLength+offsetOfFirstRecordInExtent) mod ExtentLength

Algorithm 11: Determine the actual extent position in the underlying ExtentList of a logical extent number, when ExtentList is implemented using a CircularQueue.
Set the actualExtent to the ExtentList head pointer+logicalAddress
If actualExtent>the max number of entries in the ExtentList (maxEntries)
Set actualExtent=actualextent−maxEntries

Algorithm 12: Determine the device offset of a record number.
Determine the logical extent number and the offset of the record from Algorithm 10.
Determine the actual extent of the record from Algorithm 11.
Using information stored in the Extent—device handle of extent's storage device, offset from the start of the storage device of extent (extentOffset)—calculate the offset within the device where the record should be stored.
deviceOffset=extentOffset+offsetInExtent

Algorithm 13: Write or read a specific record number.
Set bytesLeft to the size of the read/write request.
While bytesLeft in the request is greater than 0
Calculate the offsetInExtent, and the device offset of the first unprocessed data in the request as sown in Algorithm 12.
Write MIN(bytesLeft, extentSize—offsetInExtent) bytes to the device at the calculated device offset, return the number of bytes written.
Subtract bytes just written from bytesLeft.
End while loop.

Algorithm 14: Write records to the end of a DLQ.
Calculate the record number of the new record=firstRecordNumber+recordCount
Calculate the logical extent number of the start of the first new record.
Set the bytesLeft to the size of the write request
While bytesLeft in the request are greater than 0.
   Calculate the offsetInExtent, and the device offset of the first unprocessed data in the request (see Algorithm 12).
   Write MIN(bytesLeft, extentSize—offsetInExtent) to the device at the calculated device offset, return the number of bytes written.
   Subtract the number of bytes just written from the bytesLeft.
If bytesLeft is greater than 0
   Add a new extent to DLQ's Extent List (insert) from a storage pool (delete).
End the while loop

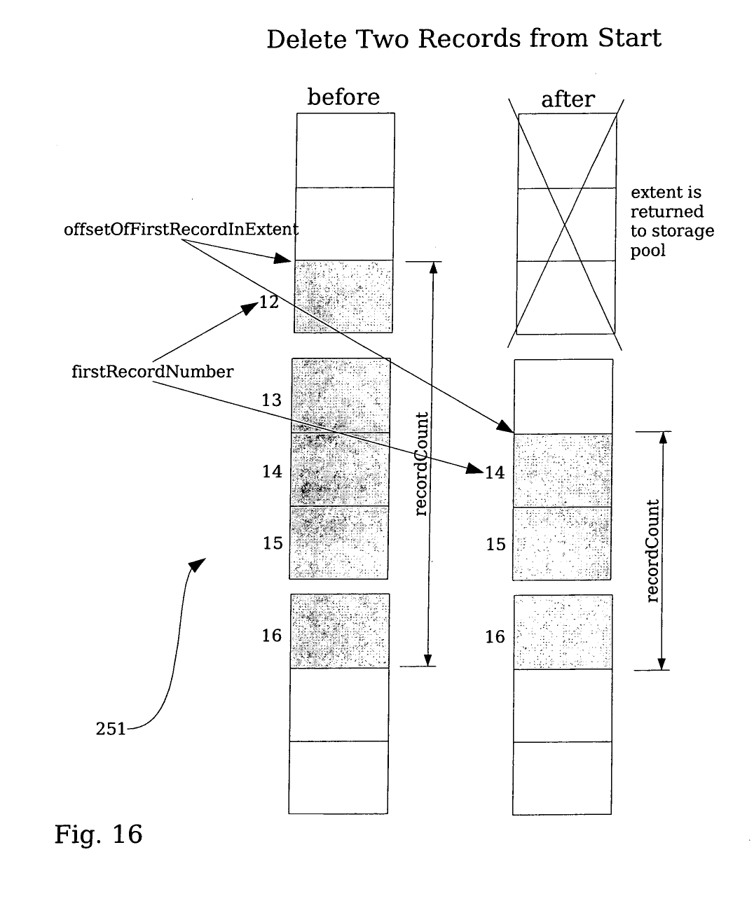

Algorithm 15: Delete n records from the front of a DLQ 251 (see example illustrated in FIG. 16).
Determine the logical extent number and the extent offset of the first non-deleted record (firstRecordNumber+n)(Algorithm 10)
Return the extents with logical numbers less than the extent number of the first non-deleted record from the beginning of the ExtentList to the storage pool.
Set offsetOfFirstRecordInExtent to the offset in extent of the first non-deleted record.
Subtract n from recordCount

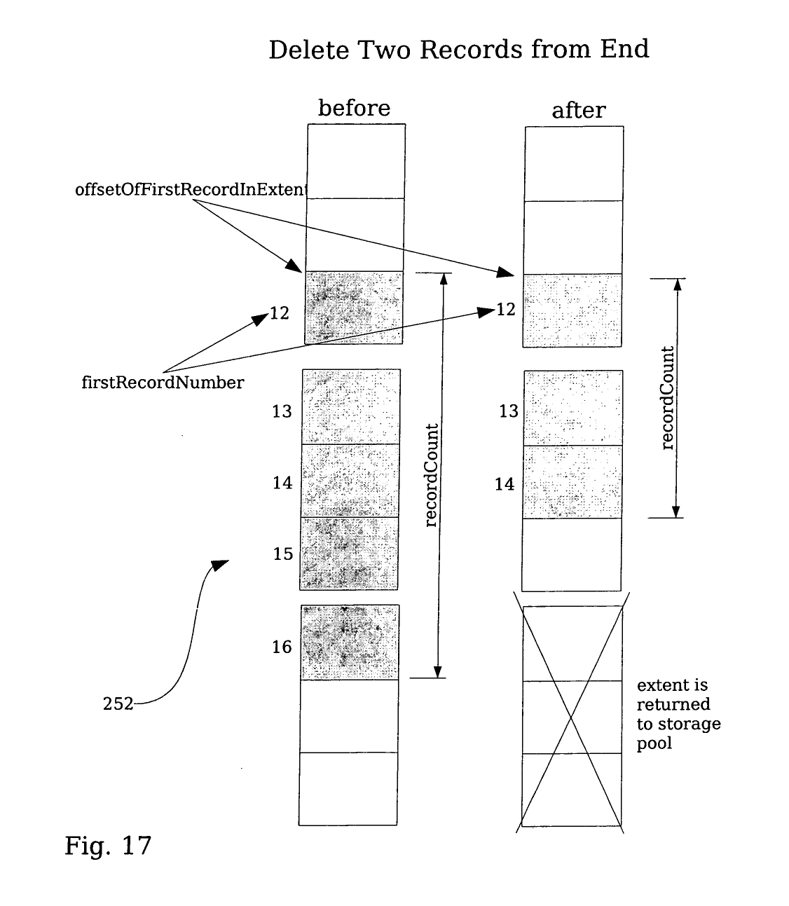

Algorithm 16: Delete n records from the end of a DLQ 252 (see example illustrated in FIG. 17).
Subtract n from the recordCount
Return extents with logical extent numbers>the extent with the last record in it to the storage pool.

Algorithm 17: Delete all the records from a DLQ.
Set offsetOfFirstRecordInExtent to 0.
Set recordCount to 0.
Return all the extents from the DLQ's extent list (delete) to the storage pool extent list (insert).

In accordance with another aspect of the present invention, each VirtualVolume periodically performs TimeRecord insertion, data movement and transformation and internal notification activities. TimeRecords created in this manner are known as interval time records. In one embodiment of the present invention, the VirtualVolume may be configured through the administrative interface to write a TimeRecord to the active CVS, create a new active CVS (to which subsequent writes are sent) and start the movement and transformation of data between VolumeSegments, all at a specified interval. In an alternate embodiment of the present invention, the interval at which these activities occur may be preconfigured or inherent in the programming. Collectively, the steps are referred to as switching the collector. Once the collector is switched, the VirtualVolume can initiate movement and/or transformation between VolumeSegments. An alternate embodiment of the present invention would not switch the collector on a scheduled basis, but would simply insert a TimeRecord into the active CVS.

A VirtualVolume may be configured with a collection of Schedules that function to determine when the collector is switched. In operation, a Schedule specifies the pattern of recurrence of the collector switching and/or TimeRecord insertion. The pattern may be equally spaced time intervals, date-based intervals or some other linear or non-linear pattern. Depending upon a particular need, a Schedule may expire after a period of time, at a specific time or recur indefinitely. A Schedule may also include the type of TimeRecord to be added.

The data stored in an Extent is stored on a raw storage device. However, part of the data may temporarily reside in a memory buffer for performance reasons. A VirtualVolume performs a monitoring activity that checks the age of data residing in memory buffers. These buffers are flushed if they are found to be older than a specified amount of time. An alternate embodiment may not use memory buffers, in which case no flushing would be done. Typically, buffers are flushed in such a manner that the data records corresponding to any given MetaDataRecord is moved to physical storage before the MetaDataRecord is moved to physical storage. Such an operation prevents data corruption in the event of a buffer loss due to some unforeseen failure—e.g., power loss or device failure.

An alternate mechanism for immediately inserting a TimeRecord into a CVS exists separate from the scheduled insertion previously described. Such a mechanism may be initiated through the administrative interface or some other interface such as a command line interface, an interrupt from a hardware device, a signal from a software program or a message transmitted over a network to name a few. In addition, the type of TimeRecord may also be specified.

Yet another TimeRecord insertion mechanism that is separate from the scheduled insertion inserts TimeRecords when certain write activity thresholds are exceeded. The thresholds can be based on the number of writes, the quantity of data written since the last TimeRecord, an occurrence of certain client address being written or any other non-time based criteria that may be contemplated but not listed.

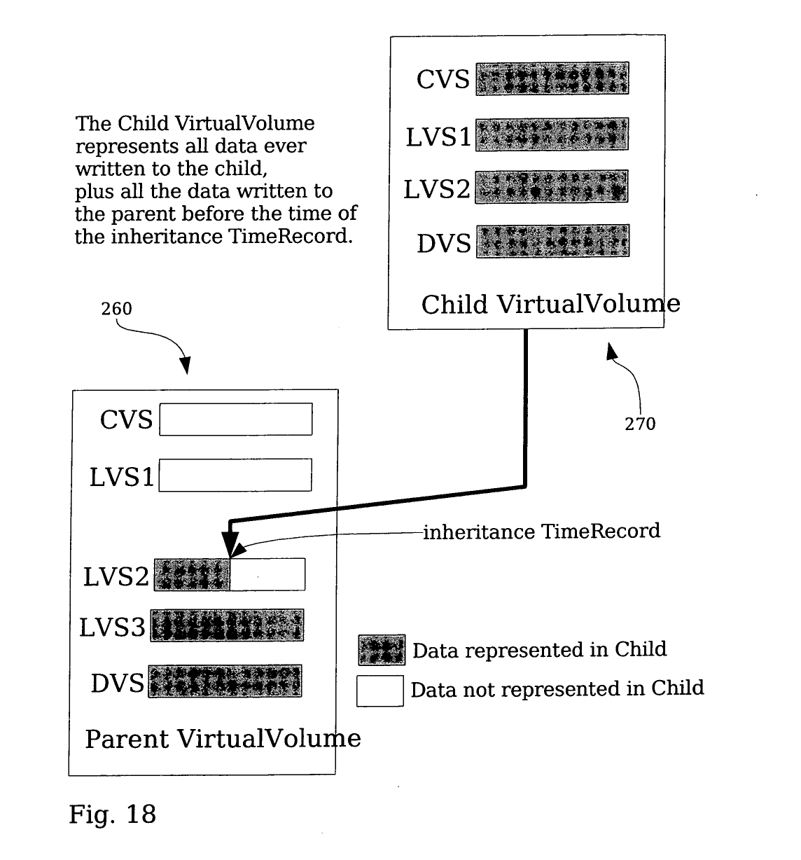

As shown in FIG. 18, a first VirtualVolume 270 may be created that inherits the data of a second VirtualVolume 260 at a point marked by a historical TimeRecord in that other VirtualVolume. Appropriately, the first VirtualVolume 270 inheriting the data is called the child VirtualVolume and the second VirtualVolume 260 providing the data is called the parent VirtualVolume. A child VirtualVolume 270 may have all the components of any other VirtualVolume, including its own set of VolumeSegments. Thus, a child may have its own write area or may be configured to be a read-only. Typically, the child is subject to a different set of policy than its parent. To reflect the state of the parent volume at the point of time of inheritance, a child VirtualVolume 270 also maintains a reference into the parent VirtualVolume 260 at the data location corresponding to its inheritance TimeRecord. Accordingly, when a TimeRecord is associated with a child VirtualVolume 270, the type field in the inheritance TimeRecord is updated to a value indicating that a VirtualVolume is inherited based on this TimeRecord. This value can be used to prevent inadvertent removal of the TimeRecord at a later time. When the child VirtualVolume 270 is destroyed, the original TimeRecord type is restored.

Child VirtualVolumes 270 are themselves complete volumes with their own policies. Accordingly, data written to a child volume will in no way affect the parent volume and common ancestral data is not duplicated in any way on behalf of the child. In addition, inherited volumes are created in a few seconds with little system resource overhead. They require little additional overhead to maintain and avoid the ongoing write overhead associated with copy-on-write snaps as implemented by other virtual storage devices. The number of volumes that can be chained together in an inheritance relationship is virtually unlimited.

In addition, a VirtualVolume may be a parent to more than one child VirtualVolume. In operation, a parent may have multiple children using different inheritance TimeRecords or a parent may have multiple children using the same inheritance TimeRecord. VirtualVolume inheritance can proceed to grandchildren and beyond forming ancestral trees of related VirtualVolumes.

In operation, a write procedure to a child VirtualVolume is performed on the child's CVS. For a read procedure on a VirtualVolume, the child's VolumeSegments are checked from youngest to oldest. If the read request client address range is not fully satisfied by the data in the child VolumeSegments, then the procedure examines the parent's data starting at the data written after the inheritance TimeRecord associated with the child. If a portion or portions of the request client address range are not found after reading from the parent and every other ancestor VirtualVolume, the unsatisfied portion or portions of the request are filled with zeros and the result is returned.

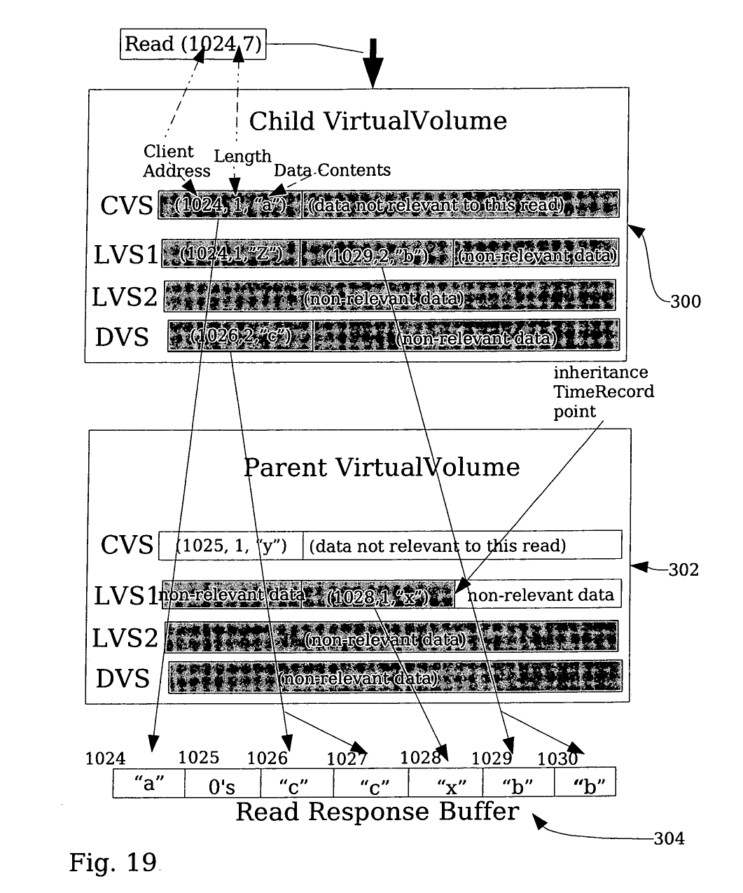

FIG. 19 illustrates an example of a read procedure performed on a child VirtualVolume 300. For every TimeRecord in a parent VirtualVolume 302 that is associated with one or more child VirtualVolumes 300, a TimeRecord index is created in the parent as well. The parent TimeRecord is defined and used herein as an inheritance TimeRecord point. When a child needs to read from its parent, it uses the TimeRecord index to read only the portion of the VolumeSegment (containing that particular TimeRecord index) chronologically before the TimeRecord. The read action then proceeds, if necessary, to the older VolumeSegments of the parent, utilizing the tip index of each VolumeSegment as previously described.

A VirtualVolume has the ability to migrate data from a sending VolumeSegment to the next chronologically subsequent receiving VolumeSegment. A data interval may delimit the amount of data to be moved and/or transformed, which is defined as the data between two TimeRecords. Other criteria for determining the amount of data to be moved and/or transformed may be tied to a fixed amount of data, available processor time or storage resource utilization to name a few.

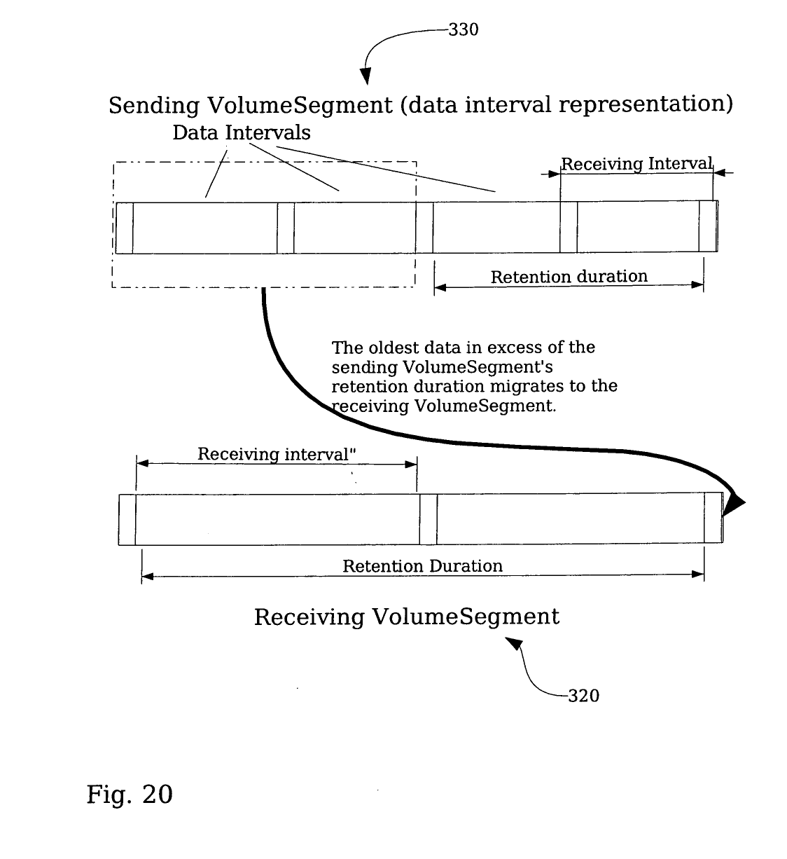

The desired time delta between adjacent interval TimeRecords of a VolumeSegment is the VolumeSegment's receiving interval. The amount moved may be limited by the sending VolumeSegment's retention duration. As that term is used herein, the retention duration is the minimum desired time interval between a VolumeSegment's earliest and most recent TimeRecords. Preferably, as shown and described in connection with FIG. 20 for data migration, no data is transferred from a VolumeSegment until the difference between the earliest and most recent TimeRecords is greater than the retention duration of sending VolumeSegment 330 plus the receiving interval of receiving VolumeSegment 320. The receiving interval of a DVS is 0. In accordance with the present invention, records may be moved between VolumeSegments in any size increments at any time interval.

As an intermediate step in the movement of the data, the data may be transformed before it is written to the receiving VolumeSegment 320. The nature of the data transformation can differ between different adjacent pairs of VolumeSegments 320, 330. In addition, multiple data transformation operations may be performed during data migration. Each type of data transformation performed between each pair of VolumeSegments 320, 330 is configurable through the administrative interface. Moreover, data transformation may take place on a single VolumeSegment without involving data movement between VolumeSegments. For example, data found to be infected by viruses may be marked in a Volume Segment as bad blocks. For a subsequent read operation, the VolumeSegment returns read errors to the client rather than returning the infected data.

Data migration and data transformation may be initiated on a scheduled basis or by events internal or external to the DSS. Any suitable method of transformations may be utilized without limiting the invention described herein. The following are for illustrative purposes only and should not be considered an exhaustive list of possible data transformation methods:
Block compression through the removal of data with redundant client address ranges, keeping only the most recent data when redundancy is present.
Screening for and removing data blocks whose content are zeros where the client address ranges of the zero content blocks are not present in older VolumeSegments.
Data compression using any valid reversible compression algorithm to reduce the size of the data.
Applying encryption or decryption to the data.
Virus detection and removal.

Preferably, when data is moved to another VolumeSegment, the associated storage in the sending VolumeSegment is marked as not in use. Accordingly, when a full Extent is no longer in use, it is eligible to be returned to its corresponding storage pool.

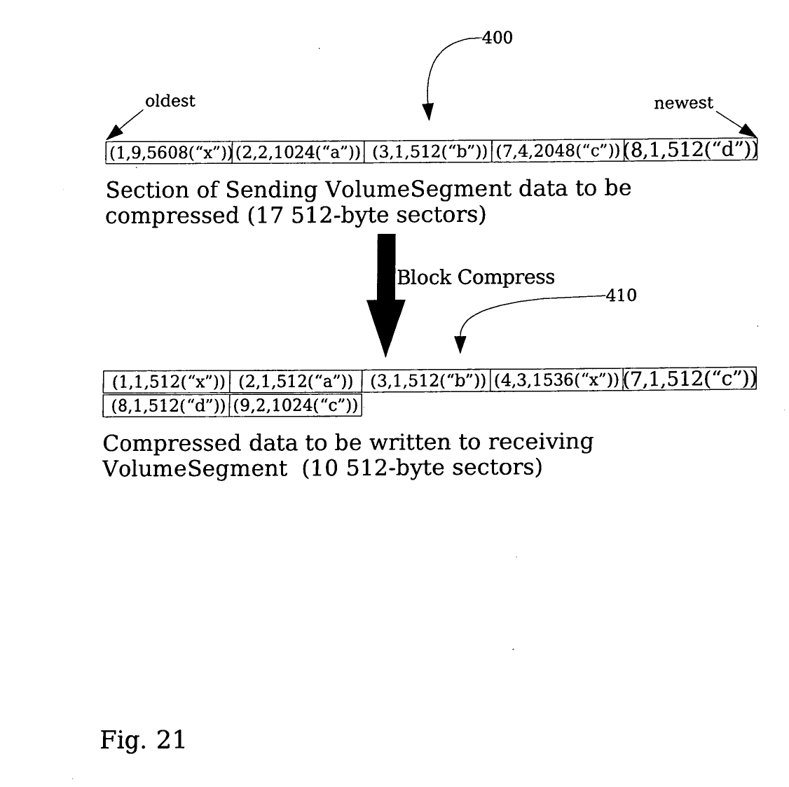

As illustrated in FIG. 21, block compression is the selective removal of data with redundant client address ranges from a given interval of journaled data 400. Any redundant intermediate values of a given block within a given interval of data in the sending VolumeSegment are not moved to the receiving VolumeSegment. Only the newest data written into the block's address during the interval is moved. Preferably, the interval of data selected in the sending VolumeSegment 400—the subject matter of a block compression operation—has a time delta corresponding to the receiving interval of the receiving VolumeSegment 410.

Alternatively, the amount of data processed in a compression event need not be dependent upon policies or even upon existing TimeRecords. Still another embodiment of the invention may process the maximum amount of data corresponding to the available processing resources, operate upon a fixed number of client write events, operate upon a fixed number of megabytes of data or pick the interval of operated data operated on by some other convenient standard. Preferably, the method selects the blocks to be moved into the receiving segment 410 in a similar manner as the method that creates a move index. The move index is then traversed so as to select data store addresses which are copied to the receiving VolumeSegment 410. The selected addresses are then read from the data store of the sending VolumeSegment 400 and subsequently written to the receiving VolumeSegment 410. After the full amount of data represented in the move index is copied to the receiving segment, a TimeRecord with the same time value and type as the TimeRecord (if any) at the end of the interval selected from the sending VolumeSegment is added to the receiving VolumeSegment 410.

Alternatively, at the completion of the creation of the move index, it could be sorted in order of data store address to preserve the order of writes as they were ordered by the client.

After the blocks represented in the move index are copied and the TimeRecord is inserted into the receiving VolumeSegment 410, the entire interval of data in the sending VolumeSegment 400 that was selected for block compression is deleted—including the ending TimeRecord, if one exists.

The data stored in an Extent is primarily stored on a raw storage device such as a disk. However, for performance reasons, parts of the data may temporarily reside in memory buffers. Preferably, a DSS may perform a monitoring activity that checks the age of data residing in Extent buffers. The buffers are flushed to raw storage if they are older than a specified amount of time. Alternatively, memory buffers may not be used at all, or may use a different flushing scheme, such as flushing only when memory is in short supply, flushing only upon device shutdown or flushing upon a hardware or software interrupt to name a few.

The data stored in an Extent is primarily stored on a raw storage device such as a disk. However, in some embodiments, parts of the data may temporarily reside in memory buffers for reasons of performance. In these embodiments, a DSS may perform a monitoring activity that checks the age of data residing in Extent buffers. These buffers may be flushed to raw storage if they are found to be older than some amount of time. Alternately, memory buffers may not be used at all, or may use a different flushing scheme, including but not limited to flushing when memory is in short supply, upon device shutdown, or when signaled by a hardware or software interrupt.

At startup (or restart), the current invention contemplates restarting any VirtualVolumes that were operational before the last shutdown or crash of the DSS. In addition, since VirtualVolumes are typically implemented as processes—or threads of a process—it is possible for a such VirtualVolumes to fail without necessarily failing the entire DSS. Accordingly, upon failing, the processes or threads will need to be restarted. It is also contemplated by the present invention that threads or processes may not be used but may instead have the VirtualVolumes be integrated with a single monolithic program or process.

At startup, a bootstrap process starts for the DSS. In operation, the bootstrap process reads configuration information that determine which VirtualVolumes are initialized and made ready. Each VirtualVolume contains within its configuration information a reference to the parent VirtualVolume, if any. This operation creates a dependency relationship that is used to select the restart order for the VirtualVolumes. When a VirtualVolume is started, it reads its configuration data and creates any missing VolumeSegments. Any existing VolumeSegments that are missing from the current configuration are moved and possibly transformed into the next VolumeSegment. Alternatively, special logic may be implemented to hold movement/transformation into obsolete segments whose duration is set to 0. Obsolete VolumeSegments that are emptied in the normal course of processing are also deleted. The metadata store of each of its VolumeSegments is read. The read information is then used to create a tip index and also any TimeRecord indexes upon which child VirtualVolumes are based. Each index is created by first starting with an empty index. Then, the index is updated with each MetaDataRecord from the metadata store, up to and including the TimeRecord upon which the index is based. Preferably, the index is updated in the order that TimeRecords occur in the metadata store and in the same manner as when the indexes were originally created—i.e., either as a result of user data being written into a CVS or as a result of block movement or compression into an LVS or DVS (see Algorithm 3 and Algorithm 4 discussed above).

Preferably, changes to policy of a running VirtualVolume may occur at any time. Such changes to properties include, for example, the number of VolumeSegments, the retention duration and receiving interval of any VolumeSegment, whether a VirtualVolume is writable and the forms of data migration or transformation. Others may be implemented by affecting the necessary change to the configuration files, then stopping and restarting the appropriate VirtualVolume. Preferably, the appropriate VirtualVolume may alternatively be signaled to re-implement its policy.

In the same manner that RAID can be used to increase performance and/or reliability of single spindle disks, Redundant Arrays of Independent Nodes (RAIN) clusters may be used to improve performance over the levels attainable by a single DSS of given ability. Multiple VirtualVolumes from multiple DSSs may be arrayed together by either the client or another high performance node in various patterns that are designed to optimize factors such as cost, speed of access or reliability to name a few examples. Because a DSS node may have knowledge of the configuration and capabilities of other nodes of the cluster, it is able to intelligently allocate VirtualVolumes in the cluster to be used as RAIN nodes.

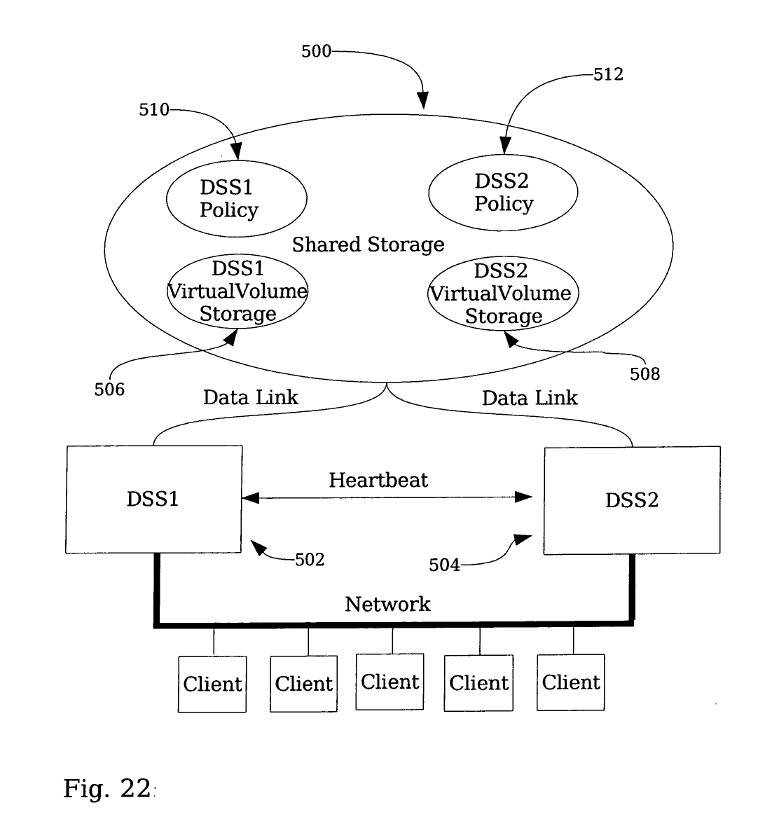

As shown in FIG. 22, a cluster of a plurality of DSS elements 500 may be configured so that storage is external to the nodes and multi-ported. Such a configuration makes it available to every node in the cluster. Accordingly, each node has access to the data storage and configuration files of the other nodes in the cluster. In the case of failure of a node, another node recognizes the failure and takes over the functions of the failing node. Optionally, it can cause the failing node to be restarted to see if it can resume its duties.

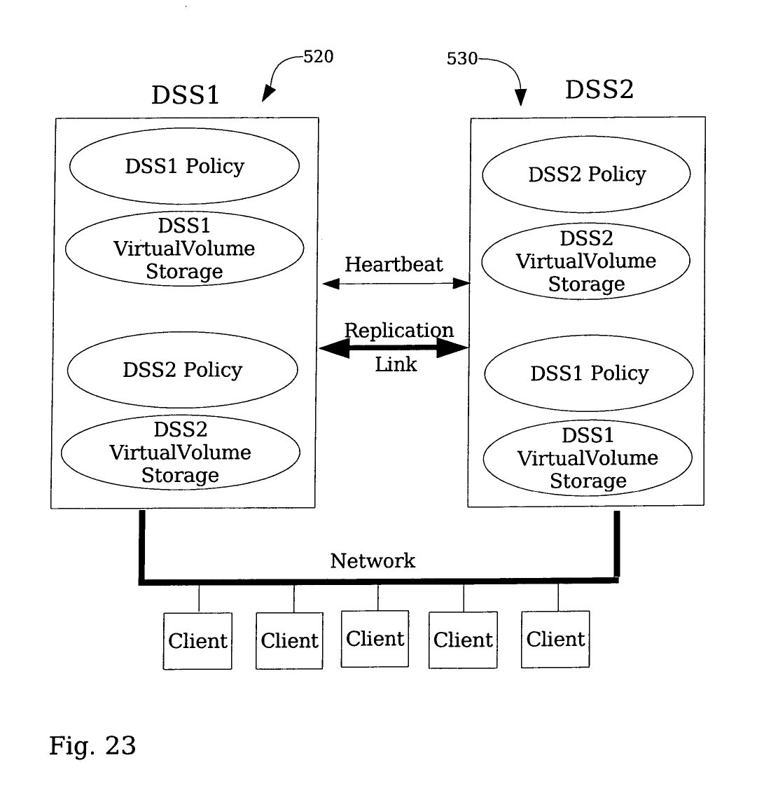

FIG. 23 illustrates a cluster of a plurality of DSS elements 520 that may be configured in such a way that VirtualVolumes and their configuration data is replicated on at least one other node 530 in the cluster. In such a configuration, each node has access to the data storage and configuration files of the each of the other nodes in the cluster. In case of failure of a node 520, another node in the cluster 530—with the replicated data and configuration of the failing node—recognizes the failure and immediately takes over the functions of the failing node. The failing node may be restarted in an attempt to resume its duties, if possible.

High availability clusters of DSS elements—whether based upon replication or shared storage devices—may be configured in such a way that each node of the cluster can actively serve up VirtualVolumes to its own clients, and still be configured to take over the duties of a failing node in the cluster. Alternatively, high availability clusters of DSSs may also be configured so that a spare node exists for each failing node. The spare nodes are inactive (not serving any clients) until they take over the duties of a failing node in the cluster.

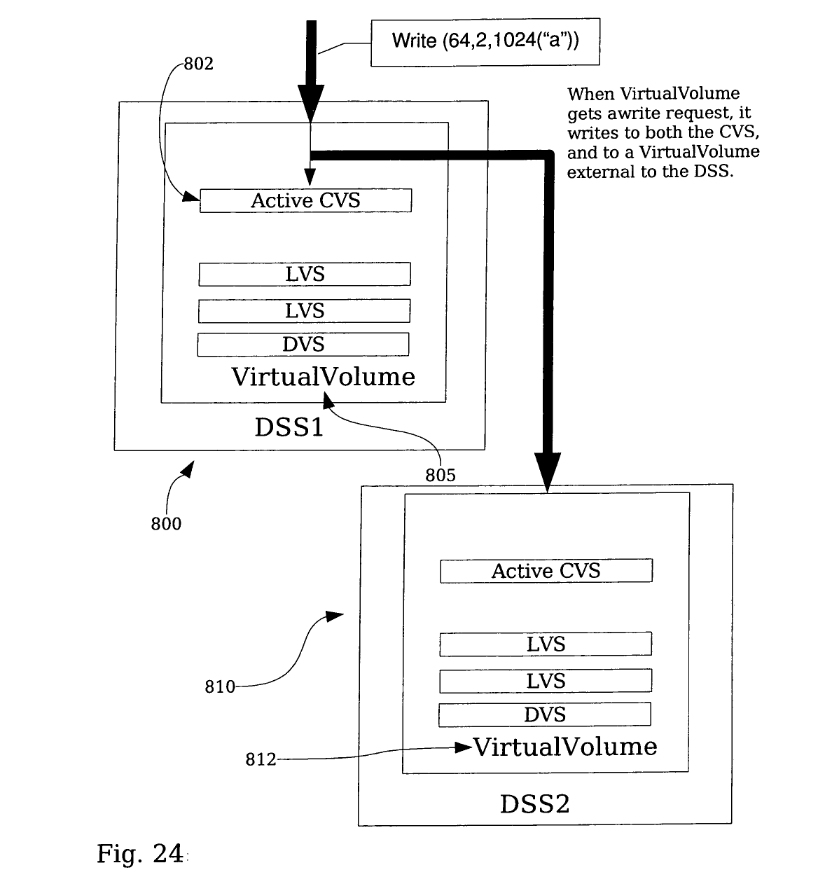

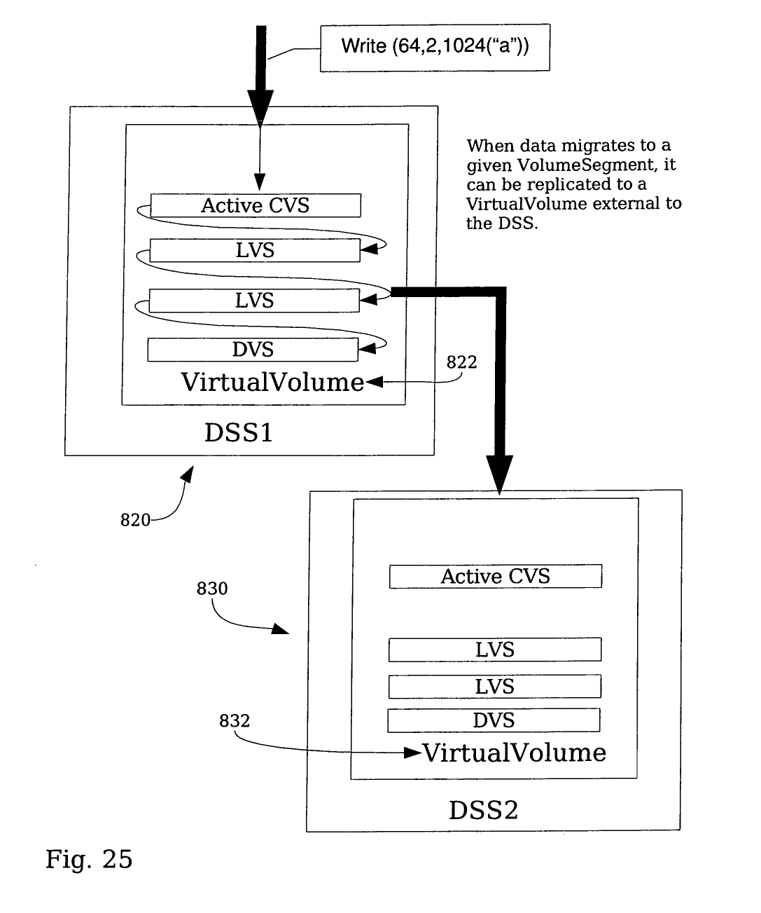

As shown in FIGS. 24 and 25, data written to a VirtualVolume 805 on a first DSS 800 may be replicated to another VirtualVolume 812 of similarly defined geometry on a second DSS 810. Such a replicating operation is in addition to writing the data to the original VirtualVolume 805. The replicating DSS 810 simply mounts the VirtualVolume 805 of the replication target DSS 800 as a client and thereafter copies write information to it. In the illustrated example of FIG. 24, a VirtualVolume 800 replicates write commands of its client to the replicated VirtualVolume 812 at the time that they are sent to the local VirtualVolume's CVS 802. Similarly, as shown in the illustrated embodiment of FIG. 25, write information may be replicated from any VolumeSegment 822 of a first DSS 800 as it is being prepared to be moved and/or transformed onto a subsequent VolumeSegment 832 of a second DSS 810. Such a replication takes advantage of any transformation or block compression done in the current or any prior moves. Alternatively, the replicated write can also be done by the first DSS 800, either through software or hardware, before the write is passed to the VirtualVolume 812 of the second DSS 810.

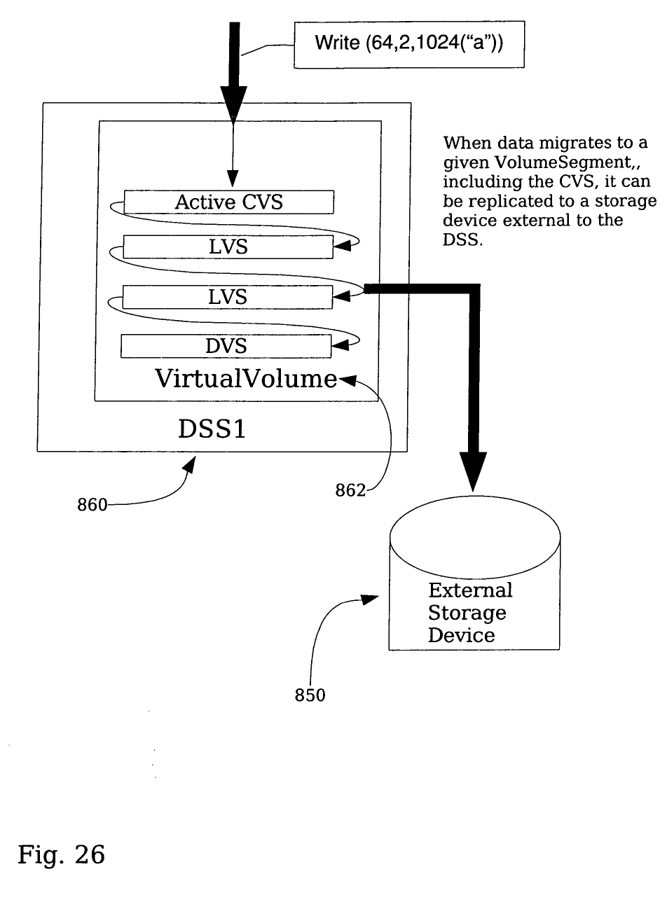

As shown in FIG. 26, similar to the DSS-DSS replication described above, any other type of block storage device 850 of similar geometry (number of sectors) may be used as a target of a replication operation. Writes may be replicated by writing to both the VirtualVolume 862 and an associated device 850. Mounting the device 850 on the DSS 860 and then copying writes to the mounted device replicates a write operand. Then, the replication process is completed by either writing to the CVS or writing to an LVS or DVS in VirtualVolume 862 as part of a moving/transforming activity.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for storing data in a queue of data entries that are ordered chronologically by time of insertion into said queue, said method comprising:
providing a list of a plurality of data items, each data item having a unique storage address range identifying regions of storage on a storage device associated therewith;
providing a data structure configured for receiving a portion of said plurality of unique storage address ranges from a pool of said addresses and returning a portion of said plurality of unique storage addresses to said pool for said addresses, said data structure having a size that is adapted to receive a plurality of data items, said data structure being extensible or contractible without having to rewrite said data structure; and
storing a data item in said data structure, said data item having a storage address in said queue that is determined at the time that said data item is stored in said data structure, said storage address being immutable without regards to any insertions and deletions from said data structure.

2. The method of claim 1, wherein said data item is of the same length as said plurality of data items.

3. The method of claim 1, wherein said data item differs in length from at least one other data item of said plurality of data items.

4. The method of claim 1, wherein said data item is stored in random access memory.

5. The method of claim 1, wherein said data item is stored on a direct access storage device, such as a hard disk.

6. A computer program product in a computer readable medium comprising functional descriptive material that, when executed by a computer, enables the computer to perform acts on the data structure of claim 1, including creating said data structure, inserting a data item or a plurality of data items to the end of said data structure, and deleting of said data item or a plurality of data items from the beginning or end of said data structure.

7. A method of data access comprising:
storing data blocks in a journal having an index associated therewith, said data blocks being paired with metadata blocks that storeinformation including a virtual address of said data block and a journal address of said data block and
storing unpaired time records in a metadata block configured to describe a point in time in said journal, said time records configured such that records appearing earlier in said journal were written at or before said point in time identified, and records appearing later in said journal were written at or after said point in time identified, said index configured to have a searchable list of virtual and journal addresses of the most recent additions to the journal of each unique virtual address range; and
retrieving said data block associated with any virtual address by, searching the index, and
retrieving data from said journal at a recorded journal address, said data block associated with a virtual address being logically replaced in subsequent write operations by performing at least one step chosen from the group consisting of adding said data block to the end of said journal and updating said index, overwriting the data blocks whose virtual addresses are represented in said journal and adding a plurality of data blocks whose virtual addresses are not represented in said journal to the end of said journal.

8. The method of claim 7, wherein said journal is stored in a data structure for receiving a portion of said plurality of unique storage addresses from said pool and returning a portion of said plurality of unique storage addresses to said pool, said data structure having a size that is configured to be extensible or contractible without having to rewrite said data structure, wherein said data block and said metadata record being stored in a separate data structure.

9. The method of claim 7, wherein said journal is stored in a data structure for receiving a portion of said plurality of unique storage addresses from said pool and returning a portion of said plurality of unique storage addresses to said pool, said data structure having a size that is configured to be extensible or contractible without having to rewrite said data structure, wherein said data block and said metadata record being stored interspersed in the same data structure.

10. The method of claim 7 wherein said journal is stored in a circular queue and wherein said data block and said metadata record being stored in separate data structures.

11. The method of claim 7 wherein said journal is stored in a circular queue and wherein said data block and said metadata record being stored interspersed in the same data structure.

12. The method of claim 7 wherein said journal is stored in a data base, wherein data records are searchable by address and wherein said data block and said metadata record are stored in separate tables or address spaces.

13. The method of claim 7 wherein said journal is stored in a data base, wherein data records are searchable by address and wherein said data block and said metadata records are stored in the same tables or address spaces.

14. A computer program product in a computer readable medium comprising functional descriptive material that, when executed by a computer, enables the computer to perform acts on the data structure of claim 7, including at least one act selected from a group consisting of:
creating of said jounal, inserting a data block and a metadata item to the end of said journal,
modifying existing data and metadata items, deleting data items from the beginning and end of the journal,
creating, searching, adding to and modifying indexes, and
reading and returning data blocks from the journal based on a request virtual device address and a contiguous length in the virtual device address space, said reading and returing occurring whether or not said data blocks are stored in contiguous journal addresses.

15. A method wherein a plurality of data blocks of a virtual volume are stored in a series of one or more of the journals of claim 7, wherein said data stored on each journal is newer than the next, wherein the most recent data stored at any virtual address can be retrieved by searching the index of each older journal in turn and retrieving the most recent data stored for that virtual address, from the newest journal where it is encountered.

16. A computer program product in a computer readable medium comprising functional descriptive material that, when executed by a computer, enables the computer to perform acts on a plurality of journals of claim 15, including:
creating said plurality of journals;
inserting data and associated metadata items to the end of a latest created journal;
modifying existing data and metadata items;
deleting data items from the beginning and end of a journal;
creating, searching, adding to, and modifying indexes;
migrating data and associated metadata blocks from a newer journal to its next oldest neighbor; and
reading and returning data blocks from the series of journals based on a request virtual device address and a contiguous length in the virtual device address space, wherein said returning occurs whether or not said data blocks are stored in contiguous journal addresses and whether or not said data blocks are stored on the same journal.

17. A method wherein an index is created that represents all the data that is older than a specific time mark in one of the journals of the claim 15, and assocatied with that time mark, wherein said index, in combination with the indexes of all older journals of the set of journals, defines a child volume that represents the state of the set of journals, and an associated virtual volume, at the time represented by the time mark

18. A computer program product in a computer readable medium comprising functional descriptive material that, when executed by a computer, enables the computer to perform acts on the child volume of claim 17, including:
creating said index; and
reading and returning a plaurality of data blocks from said journal based on a request virtual device address and a contiguous length in the virtual device address space, wherein said reading and returning occurs whether or not the data blocks are stored in contiguous journal addresses and whether or not the data blocks are stored on the same journal.

19. A method of claim 17 wherein said child volume is augmented by a virtual volume, thereby making a writable child virtual volume whose data contents may differ from the parent volume over time, and wherein the journals of the augmenting virtual volume are searched, in order from youngest to oldest, before searching the child volume index, and wherein new data can be written to the child virtual volume by writing the data to the newest journal of said augmenting virtual volume, and wherein writing to said child virtual volume does not affect the integrity of said parent virtual volume

20. A computer program product in a computer readable medium comprising functional descriptive material that, when executed by a computer, enables the computer to perform acts on the writable child volume of claim 19, including:
creating said index;
reading and returning data blocks from the journal based on a request virtual device address and a contiguous length in the virtual device address space, wherein said reading and returning occurs whether or not the data blocks are stored in contiguous journal addresses and wherein said reading and returning occurs whether or not the data blocks are stored on the same journal; and
writing or rewriting data stored on said writable child volume.

21. A method for replicating a state of a virtual volume on a data storage system comprising:
transferring over a network all information required to reproduce all known prior states of a virtual volume associated with said first data storage system to a second data storage system that is remotely located; and
writing all data and time metadata records recorded in a journal associated with said virtual volume to said second data storage system, said data and time metadata being written in the same order that they were recorded in said journal.

22. A virtual storage device comprising:
one or more physical storage devices each having a plurality of storage extents, each of said storage extents having a unique address and configured for storing data therein;
a storage pool having a plurality of said storage extents; and
a virtual storage volume having a plurality of volume segments, each of said volume segments having a first queue and a second queue, said first queue configured for storing data and said second queue configured for storing a record identifying a location of said data in said first queue, said first and second queues configured for drawing storage space from said storage pool in response to a need for storing an element in said first or second queue and returning said storage space to said storage pool in response to a need for removing an element from said first or second queue.
